(19) United States
(12) Patent Application Publication
(10) Pub. No.: US 2002/0091496 A1
(43) Pub. Date: Jul. 11, 2002

(54) Method for developing testing program of tester

(76) Inventors: Yi-Jen Cheng, Hsinchu (TW); Deng-Kai Yang, Hsinchu (TW)

Correspondence Address: Niro, Scavone, Haller & Niro, Suite 4600, 181 West Madison, Chicago, IL, 60602-4515, US

(21) Appl. No.: 09/846,939

(22) Filed: Apr. 30, 2001

(30) Foreign Application Priority Data
Nov. 28, 2000 (TW) 89125261

(51) Int. Cl. G06F 9/44; G06F 19/00; G01M 19/00

(52) U.S. Cl. 702/123

(57) ABSTRACT

A method for automatically developing a testing program of a tester is provided. The method includes steps of establishing an intellectual property, integrating the intellectual property with a product target specification, an error code list and a program transfer rule check, and automatically developing a prototype of the testing program. The intellectual property includes a tester library, a tester resource installation configuration and a testing strategy.

### FIELD OF THE INVENTION

The present invention relates to a method for developing a testing program, and more particularly to a method for automatically developing a testing program of a tester to be used for chip designing.

### BACKGROUND OF THE INVENTION

Nowadays, chips are quickly developed and designed in accordance with system on chip (SOC). Thus, the functions of chips are more powerful. However, there exist some problems, such as the complexity of testing chips, the development of testing programs, the transfer among different testers and the modification of the programs, which would increase the cost of maintenance.

In order to solve the above problems, it is important to utilize intellectual property (IP), in particular, chip design IP and tester IP to automatically develop source code prototype of a testing program. Therefore, it is more convenient, more efficient and less costly to develop a new testing program.

### SUMMARY OF THE INVENTION

It is an object of the present invention to provide a method for automatically developing a testing program of a tester.

It is an object of the present invention to provide an intellectual property of testers for automatically developing a testing program of a tester and reducing the testing cost of chips.

According to the present invention, the method for automatically developing a testing program of a tester includes steps of establishing an intellectual property, integrating the intellectual property with a product target specification, an error code list and a program transfer rule check, and automatically developing a prototype of the testing program.

In accordance with an aspect of the present invention, the intellectual property includes a tester library, a tester resource installation configuration and a testing strategy.

Preferably, the tester is one of a digital tester and an analog tester.

Preferably, the tester library includes pattern file formats and source code prototypes for a plurality of known testers.

Preferably, the tester resource installation configuration includes Pin electronics (PE) specification and maximum channels, precision measurement unit (PMU) specifications, device power supplies (DPS) specifications, time measurement unit (TMU) specifications, vector memory size specifications, system clock rate specifications and analog channel specifications.

The testing strategy includes a testing item selected from one of a logical product and an analog product. Preferably, the testing item of the logical product is one selected from a group consisting of continuity test, drive/sink current test, power dissipation test, IDDQ test, input leakage current test, function pattern test and AC characteristic test. The testing item of the analog product is one selected from a group consisting of ADC/DAC's SNR test, THD test, Jitter/Skew test, crosstalk test, eye diagram test and frequency response test.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 shows the tester library according to a preferred embodiment of the present invention;

FIG. 2 shows the tester resource installation configuration according to the preferred embodiment of the present invention;

FIG. 3 shows the testing items of the testing strategy according to the preferred embodiment of the present invention; and

FIG. 4 is a view illustrating the source code prototype of a testing program is developed by being integrated with the tester library, the tester resource installation configuration and the testing strategy according to the preferred embodiment of the present invention.

### DETAILED DESCRIPTION OF THE PREFERRED EMBODIMENTS

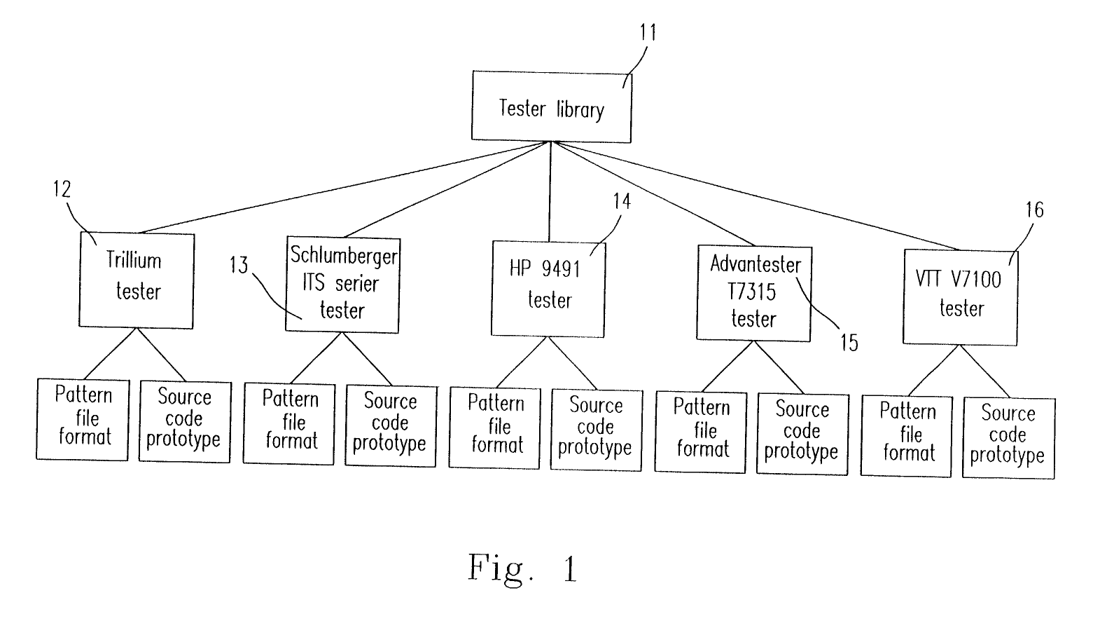

Referring to FIG. 1, the tester library 11 according to a preferred embodiment of the present invention includes information of five testers, for example Trillium Tester 12, Schlumberger ITS serier Tester 13, HP 9491 Tester 14, Advantester T7315 Tester 15 and VTT V7100 Tester 16. The pattern file format and the source code prototype of testing program of each tester are provided in accordance with the user's demand. In addition, the testing programs for satisfying the same testing demand could be converted into the testing programs of other testers. Preferably, the tester source code is implemented by using a C language or a Pascal language. Certainly, the tester of the present invention can be one of a digital tester and an analog tester.

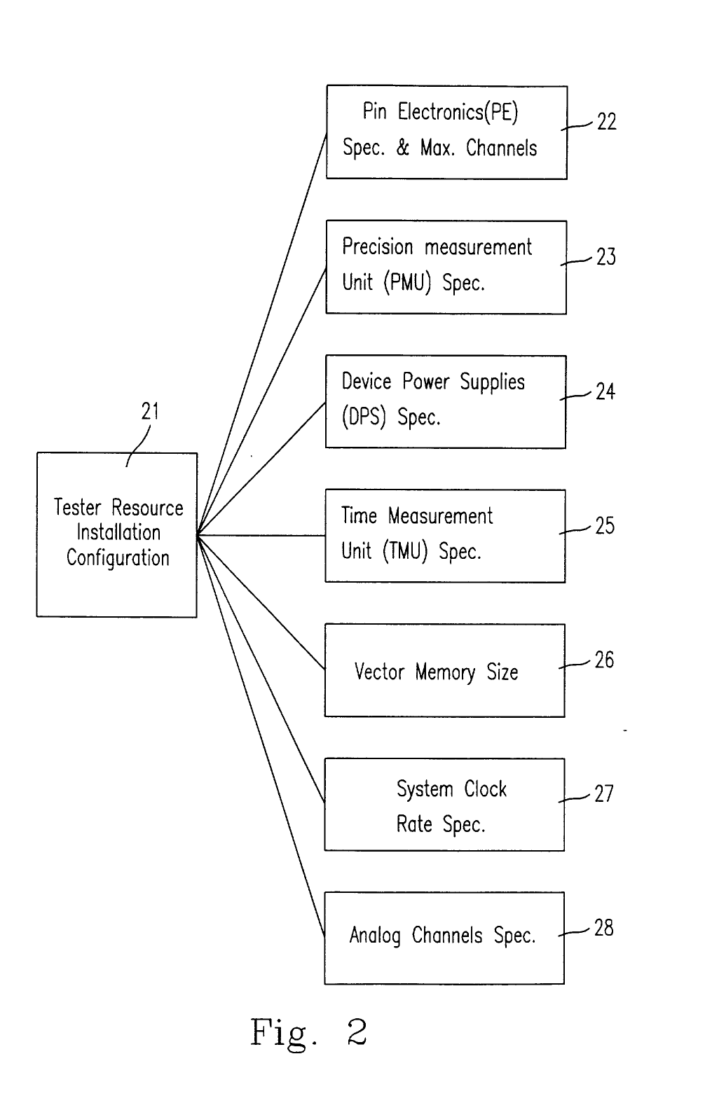

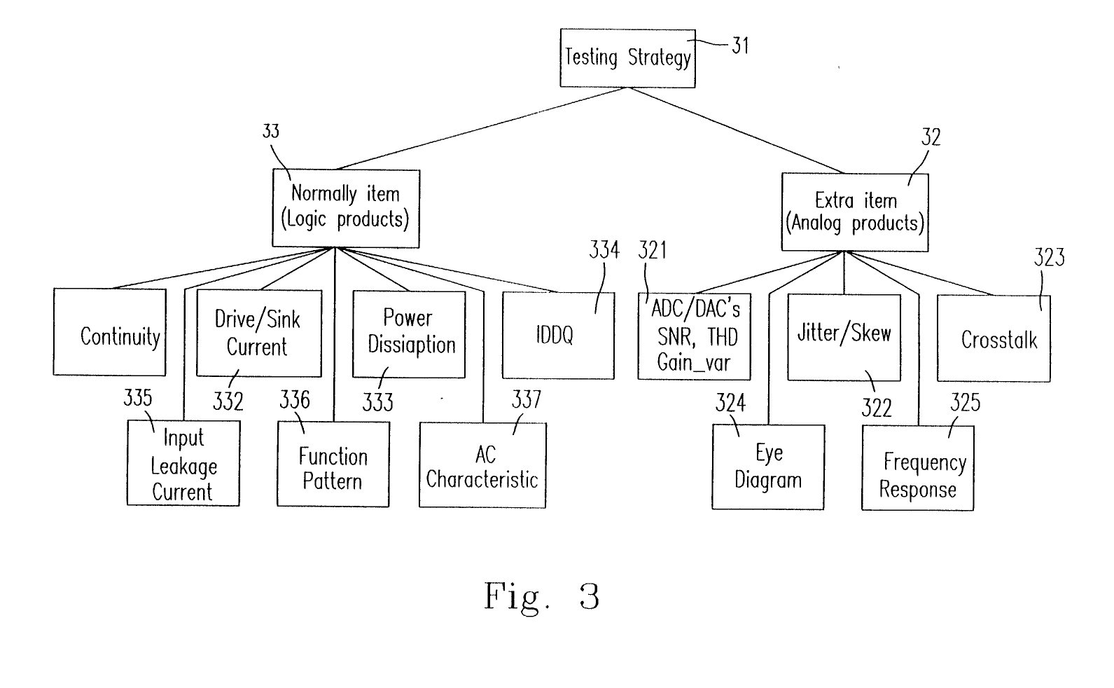

FIG. 2 shows the tester resource installation according to the preferred embodiment of the present invention. The inputting conditions of the IP are defined in accordance with the testers and the electrical specification. The testing programs and the pattern files allowed for a user will be developed according to the pre-set inputting conditions. The tester resource installation configuration 21 shown in FIG. 2 essentially includes Pin electronics (PE) specification and max. channels 22, a precision measurement unit (PMU) specification 23, a device power supplies (DPS) specification 24, a time measurement unit (TMU) specification 25, a vector memory size specification 26, a system clock rate specification 27 and an analog channel specification 28. FIG. 3 shows a testing strategy according to the preferred embodiment of the present invention. The item of the testing strategy 31 includes a normally item 33, i.e. a logical product, and an extra item 32, i.e. an analog product. The normally item 33 essentially includes continuity 331 test, drive/sink current test 332, power dissipation test 333, IDDQ test 334, input leakage current test 335, function pattern test 336 and AC characteristic test 337. The extra item 32 further includes ADC/DAC's SNR and THD test 321, Jitter/Skew test 322, crosstalk test 323, eye diagram test 324 and frequency response test 325.

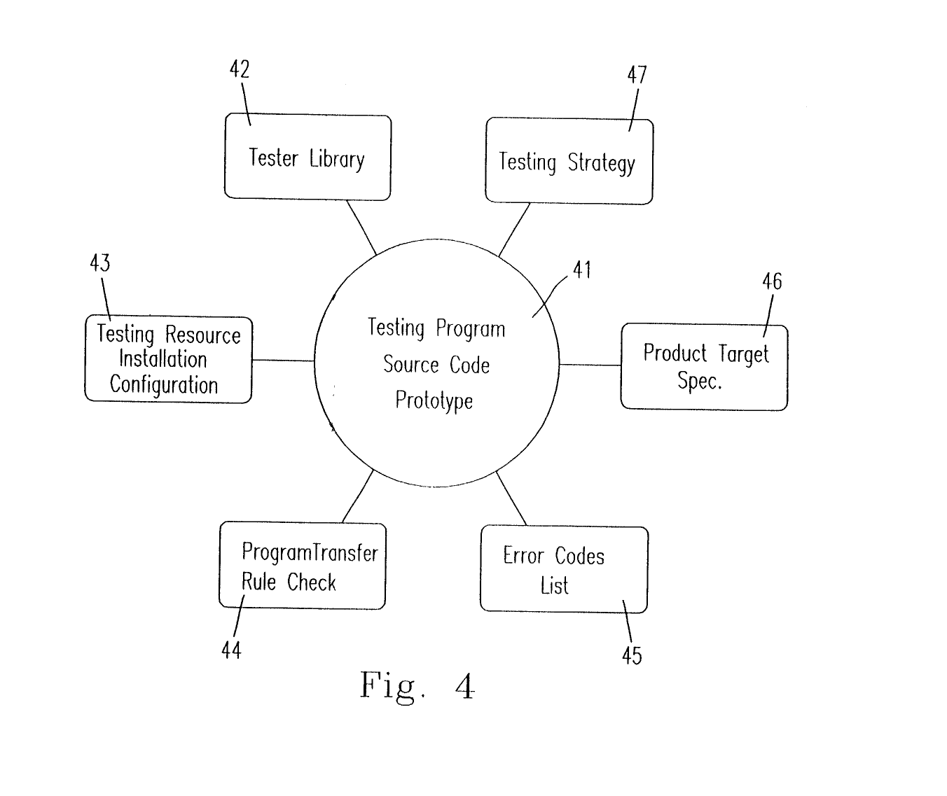

The IP according to the present invention can be implemented by using C language or C Shell Script. Please refer to FIG. 4, the testing library 41, the tester resource installation configuration 42 and the testing strategy 43 could be effectively integrated with a product target specification 44, an error code list 45 and a program transfer rule check 46 to form the test program source code prototype 47 according to the present invention. In addition, the IP according to the present invention could be executed in a personal computer (PC) or a workstation so as to increase speed of development of the testing programs.

While the foregoing has been described in terms of preferred embodiments of the invention, it will be appreciated by those skilled in the art that many variations and modifications may be made without departing from the principles and spirit of the invention, the scope of which is defined by the appended claims.

What is claimed is:

1. A method for automatically developing a testing program of a tester, comprising steps of:
establishing an intellectual property comprising a tester library, a tester resource installation configuration and a testing strategy;
integrating said intellectual property with a product target specification, an error code list and a program transfer rule check; and
automatically developing a source code prototype of said testing program.

2. The method according to claim 1, wherein said tester is one of a digital tester and an analog tester.

3. The method according to claim 1, wherein said tester library comprises pattern file formats and source code prototypes for a plurality of known testers.

4. The method according to claim 1, wherein said tester resource installation configuration comprises Pin electronics (PE) specification and maximum channels, a precision measurement unit (PMU) specifications, a device power supplies (DPS) specification, a time measurement unit (TMU) specification, a vector memory size specification, a system clock rate specification and an analog channel specification.

5. The method according to claim 1, wherein said testing strategy comprises a testing item selected from one of a logical product and an analog product.

6. The method according to claim 5, wherein said testing item of said logical product is one selected from a group consisting of continuity test, drive/sink current test, power dissipation test, IDDQ test, input leakage current test, function pattern test and AC characteristic test.

7. The method according to claim 5, wherein said testing item of said analog product is one selected from a group consisting of ADC/DAC's SNR test, THD test, Jitter/Skew test, crosstalk test, eye diagram test and frequency response test.
